(19) United States
(12) Patent Application Publication
(10) Pub. No.: US 2008/0178557 A1
(43) Pub. Date: Jul. 31, 2008

(54) WEATHER BARRIER STRUCTURE AND METHODS FOR ARCHITECTURAL OPENINGS

(75) Inventors: Gary D. Parsons, Midland, MI (US); Jeff M. Hansbro, Evanston, IL (US); Joseph A. Langmaid, Caro, MI (US)

Correspondence Address: DOBRUSIN & THENNISCH PC, 29 W. LAWRENCE STREET, STE. 210, PONTIAC, MI, 48342, US

(73) Assignee: Dow Global Technologies Inc.

(21) Appl. No.: 12/021,692

(22) Filed: Jan. 29, 2008

Related U.S. Application Data
(60) Provisional application No. 60/887,490, filed on Jan. 31, 2007.

(51) Int. Cl. E06B 7/14

(52) U.S. Cl. 52/741.1; 52/58; 52/61; 52/745.19

(57) ABSTRACT

An improved flashing for sealing an opening of an architectural structure, comprising a generally vertically disposed substantially planar forward portion having an upper end and a lower end. A base portion rearwardly projects generally from the upper end of the forward portion and has an upper surface that includes a generally inclined portion and also includes a plurality of outwardly projecting spaced apart ribs. Kits and methods employing the flashing are described as well.

### CLAIM OF PRIORITY

The present application claims the benefit of the filing date of Provisional Application No. 60/887,490 (filed Jan. 31, 2007) the contents of which are hereby incorporated by reference in their entirety.

### FIELD OF THE INVENTION

The present invention pertains to construction materials, and more particularly to materials and systems for improving protection against weather elements for openings in architectural structures such as window openings, door openings or both.

### BACKGROUND OF THE INVENTION

The use of flashings in connection with architectural openings is illustrated in patents such as U.S. Pat. Nos. 4,555,882; 6,941,713; and 6,725,610, all incorporated by reference. The employment of thin walled vacuum-formed or thermo-formed has been disclosed in published U.S. Application No. 2005/0034385 (Broad et al), incorporated by reference. The latter system offers numerous advantages over prior systems due, at least in part, to the existence of thin-walled structures.

There remains a desire in the construction industry to improve sill flashings and systems incorporating the same including, for example, by improving one or more of structural rigidity, moisture management, ease of installation, or other attributes of the system. There also remains a need in the industry for facilitating one or more of the packaging, transport and distribution of construction materials, particularly kits of materials useful for improving weather resistance of architectural structures.

### SUMMARY OF THE INVENTION

The present invention meets the above needs by providing improved articles, assemblies, methods and kits that relate to flashings for openings in building structures, and more particularly to flashings that are installed during or substantially immediately following rough carpentry in new construction of residential dwellings, or in renovation or remodeling construction.

In general, the invention relates to an improved flashing for sealing an opening of an architectural structure, comprising a generally vertically disposed substantially planar forward portion having an upper end and a lower end, a base portion rearwardly projecting generally from the upper end of the forward portion and having an upper surface that includes at least one generally inclined portion and also including a plurality of outwardly projecting ribs. The flashing typically will be a thin-walled structure, e.g., less than about 3 mm (e.g., less than about 2.5 mm), and more specifically on the order of about 0.2 mm to about 1.4 mm, such as one that includes, consists essentially of, or consists of a thermoplastic film that has been thermoformed (with or without application of a vacuum), and thus may be substantially transparent, colored, surface coated or any combination thereof, over at least a portion of its length. The flashing may include one or more sidewall portions, a rear wall extending generally upwardly from the base portion or a combination thereof.

The above flashing may be part of an architectural structure assembly that includes an opening (e.g., defined in a structural frame, such as one made of metal, wood, composite material or otherwise) selected from a window opening, a swinging door opening, a sliding door opening, or any combination thereof. In one particular embodiment, the assembly is free of any shim beneath the flashing. The flashing may be secured to a frame (e.g., an underlying frame) by at least one bead of adhesive, a tape, a staple, a fastener, or any combination thereof.

The flashing herein may be provided alone or with one or more other construction materials, such as in a kit. Advantageously, the structure of the flashing permits it to be packaged and transported in a relatively compact volume, such as achievable by stacking a plurality of the flashings so that the respective base portions are in contact with each other.

### DESCRIPTION OF THE DRAWINGS

FIG. 1 is a perspective view of an illustrative flashing system according to the present invention.

FIG. 2 is a top plan view of the flashing system of FIG. 1.

FIG. 3 is a front elevation view of the flashing system of FIG. 1.

FIG. 4 is an enlarged perspective view of a flashing in accordance with the present invention.

FIG. 5A is an enlarged front elevation view of a portion from FIGS. 1 through 3.

FIG. 5B is a top plan view of the flashing system of FIG. 5A.

FIGS. 6A and 6B are sectional views taken respectively through A-A and B-B of FIG. 5A.

FIG. 6C is a side view of FIG. 5A.

FIGS. 7A-7M illustrate examples of steps to construct an assembly in accordance with the present invention.

FIGS. 8A-8G are views of examples of rib structures herein.

### DETAILED DESCRIPTION

In general, the invention relates to an improved flashing for sealing an opening of an architectural structure, comprising a generally vertically disposed substantially planar forward portion having an upper end and a lower end, a base portion rearwardly projecting generally from the upper end of the forward portion and having an upper surface that includes at least one or a plurality of generally inclined portion and also including a plurality of outwardly projecting ribs. The flashing typically will be a thin-walled structure, e.g., less than about 3 mm (e.g., less than about 2.5 mm), and more specifically on the order of about 0.2 mm to about 1.4 mm, such as one that includes, consists essentially of, or consists of a thermoplastic film that has been thermoformed (with or without application of a vacuum), and thus may be substantially transparent, colored, surface coated or any combination thereof, over at least a portion of its length. The flashing may include one or more sidewall portions, a rear wall extending generally upwardly from the base portion or a combination thereof.

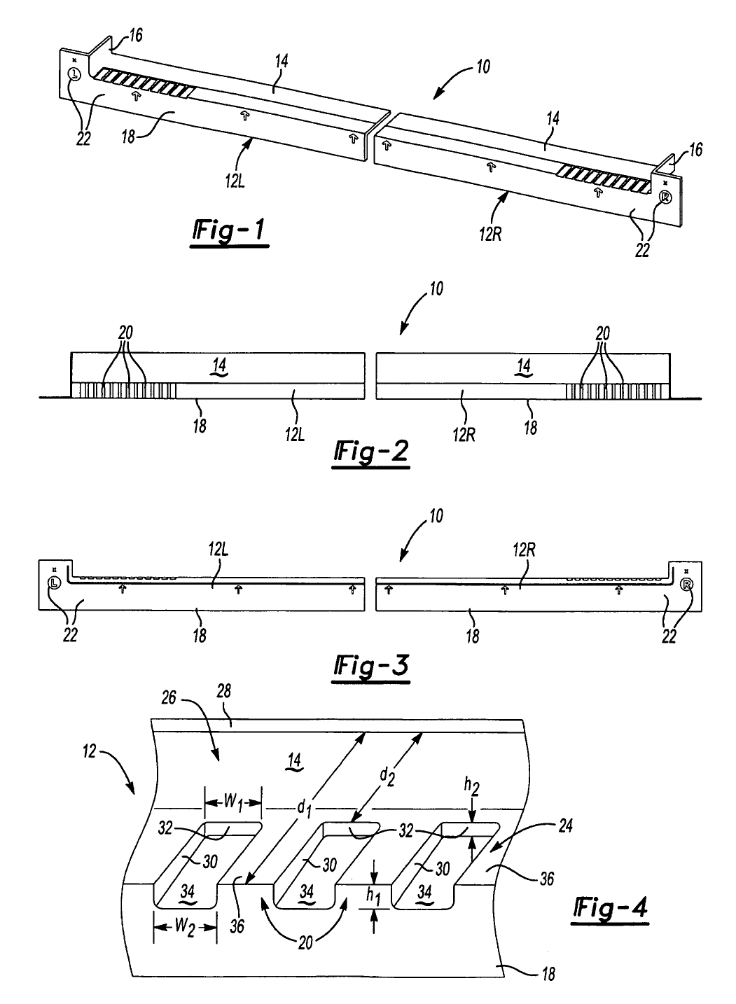

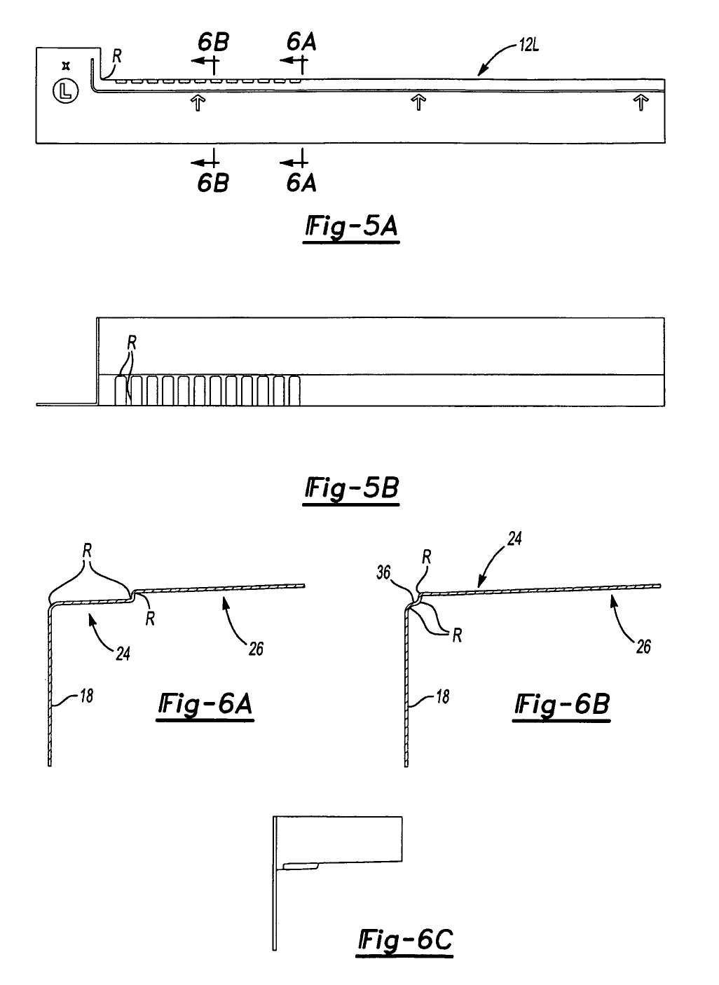

With further attention to the embodiments disclosed by way of illustration in the drawings of FIGS. 1 through 3, it is seen that a flashing system 10 herein generally includes a first flashing 12L and a second flashing 12R. The use of L and R as reference designations herein is for convenience in describing the invention. It is not intended to limit the invention to any preferred location or orientation. Further, the depiction herein of first and second flashings is not intended to foreclose the presence of additional flashing segments, such as a segment that would overlap or abut one or both of the first or second flashings. Moreover, the depiction of first and second flashings as separate portions is not intended to foreclose the integration of the first and second flashings into a single unitary structure. Additionally, it will be seen, with reference to FIGS. 5A-6C that, though the description is illustrated with particular reference to the first flashing 12L, in one preferred embodiment (e.g., as shown in FIGS. 1 through 3), the second flashing 12R will commonly exhibit a generally symmetrical configuration relative to an orthogonal axis therebetween. Thus, generally the description provided for one of the flashings covers like structures in the opposite side flashing. Of course, it is to be borne in mind that the first flashing 12L and the second flashing need not always be generally symmetrical, but may vary with respect to each other in one or more respects, including but not limited shape, dimension, material, or other attribute.

The flashings 12L and 12R typically will each have a unitary structure that has a generally continuous surface. Desirably, though not required, the flashings will be a relatively thin-walled structure, and particularly will have thickness variations (namely, 100%×(the largest part thickness−the smallest part thickness)/ the largest part thickness), over the entire part of less than about 35%, more preferably less than about 25%, and even still more preferably less than about 15%. However, it may be expected, for example in thermoformed parts, the like, or otherwise, the thickness over the entire part may vary greater than about 35%. Though a preferred wall thickness for the flashings herein will be about 0.1 to about 3 mm (e.g., less than about 2.5 mm), and more preferably about 0.5 to about 1.5 mm, (e.g., about 1 mm), or otherwise described herein, larger or small thicknesses are also possible. Desirably the flashings of the invention will be made from a plastic sheet or film (e.g., about 1.3 mm thick or less), and more specifically will be thermoformed from a plastic sheet or film, and still more preferably will be vacuum formed from a plastic sheet or film.

Again with reference to FIGS. 1 through 3, the flashings 12L and 12R generally will include a base portion 14, which in many service applications generally will be disposed substantially orthogonally relative to an exterior wall surface to which it is affixed. Disposed at or near an end of the flashings 12L and 12R there will be a side flange 16 that projects away from the base portion, such as by projecting substantially orthogonally relative to the base portion. The side flange 16 is shown as extending to the rear of the flashing with a substantially constant height. However, the height need not necessarily be substantially constant. It may vary along the depth of the flashing; it may have one or more curvatures, slopes, cut-outs, or other variation in height. In addition, typically, the flashings herein will include a forward wall defining a front surface 18. As with the side flange, though shown as a generally constant height, the front surface may vary along the length of the flashing; it may have one or more curvatures, slopes, cut-outs, or other variation in height. In plan view, the front surface 18 generally is L-shaped. However, it need not be. Other variations are possible.

The flashings of the invention may further be characterized as including one or more variations in topography along the base portion, the front surface or both. More specifically, it is contemplated that either or both of the base portion 14 or the front surface 18 will be shaped to define a plurality of ribs 20, marking indicia 22 or both along substantially all, or only a portion of the length (e.g., less than about 50% of the length) of the flashing. For example, the marking indicia may include one or more of a trademark or other source designator, product use instructions, product recycling designations, measuring aids (e.g., markings of measurement units), leveling indicators, contact information, side designation (e.g., left, right, up, down, or otherwise), fastener locators, patent markings, use prohibitions, any combination thereof, or the like).

With additional reference to FIG. 4, there is seen in enlarged detail one example of a possible rib structure on a sill flashing. At least one, and more preferably a plurality of ribs 20 generally exist in a forward portion 24 of the base 14 of the flashing 12. A rearward portion 26 includes a generally continuous surface, that may be substantially smooth, or itself include a topography. Also shown in FIG. 4 is an optional rear wall 28, which generally will be projecting upward and away from the rearward portion 26, such as from or near a rearmost edge of the flashing. In the embodiment of FIG. 4, the ribs are shown as having a forward upper portion that is generally co-extensive with the front surface 18 of the flashing. Such a structure may be varied as desired. For instance, it is possible that the forward upper portion may include a stepped portion (S) recessed behind the front surface 18. Such a structure is illustrated in the view of FIG. 6B. Referring again to FIG. 4, one possible rib structure is illustrated as including one or more wall portions (e.g., a side wall portion 30 and a rear wall portion 32) that extend generally upwardly from a valley floor 34. The intersection of the wall portions with the forward portion 24 of the base effectively defines the upper surface 36 of the ribs. Though shown in FIG. 4 as generally orthogonally disposed relative to the valley floor 34, the wall portions 30 and 32 may be disposed at any desired angle (e.g., at an angle greater than 90 degrees, or even at an angle greater than 120 degrees). The valley floor and one or more of the wall portions may also form a curved surface, such as a continuously curved surface. The spacing between the ribs may vary from rib to rib, the spacing may be substantially identical from rib to rib, or both. Further, the spacing may be the same, it may vary, or a combination thereof, as the rib progresses toward the rear of the flashing. By way of illustration, a first spacing w₁ toward the rear of the flashing may be the same or different (e.g., wider or smaller) relative to a second spacing w₂, toward the front of the flashing. It will also be appreciated that the height of one or more of the ribs may vary along the rib. Thus, a first rib height h₁ toward the forward part of the rib may be the same or different (e.g., taller or shorter), than a second rib height h₂ toward the rear. The first rib height (h₁) may range from about 1% to about 95% or higher of the height of the front surface, (e.g., h₁ of about 5% to about 20% of the height the front surface). In one preferred embodiment, h₁ is substantially the same as h₂, though not required.

Also shown in FIG. 4 is a depiction of depths of the ribs relative to a general overall depth d₁ of the base portion 14. A depth d₂ from the rear edge of the base portion 14 to the rear wall portion 32 of the rib will generally be smaller than the depth d₁. However, in certain circumstances, for example, such as in a full depth wood window, the like, or otherwise, it is appreciated that the distance d₂ may be substantially smaller than d₁, such that the distance d₂ is about zero. Preferably, the distance d₂ is greater than zero. The difference A between d₁ and d₂ may be substantially the same or may vary from rib to rib. For example, the difference A from rib to rib may be progressively larger toward the outer sides of the flashing than toward the middle, such as to accommodate a larger extent of moisture accumulation that potentially may arise adjacent vertical jambs. Wherein the distance d₂ is greater than zero, the ratio of d₁/d₂ may range from about 1:1 to about 100:1 more specifically it will be about 1.2:1 to about 4:1 and more specifically about 1.5:1 to about 3:1. In one embodiment, the average depth of the ribs from the front wall 18 toward the rear of the base portion 14 is from about 0.1 to 0.8 of the depth (d₁) of the base 14, and more specifically it is about 0.2 to about 0.6.

In one embodiment herein the valley floor 34 between ribs is a generally inclined surface, wherein the surface inclines downward toward the forward face of the flashing. For example, the valley floor may have one or more slopes of about 0.5 to about 20 degrees or greater relative to a horizontal plane. More specifically, it may have one or more slopes of about 1 to about 10 degrees relative to a horizontal plane. One example of such a slope is illustrated in FIGS. 6A -6C. It is also possible that the valley floor will have substantially no slope, such that the floor can be contacted substantially flush with a frame member along at least about one half the depth of the rib, and more preferably over substantially the entire depth of the rib. It is believed possible that by using the construction shown herein that the upper surface of the rib that is part of the of the forward portion 24 of the base will have only a slight slope, if any at all. It should be appreciated that it is possible that the ribs themselves have only a slight slope, if any, allowing them to be substantially parallel to the base frame member of a rough opening, and the lower end of a window or other panel installed thereover. The valley floor of the ribs thus is capable of sitting on the base frame member, with the top of the rib contacting the window or other panel. In this manner, it is believed possible to substantially avoid having the weight of the window or other panel crush or flatten the forward portion 24 of the base. Thus, the ribs may be configured for spacing the forward portion 24 of the base from the bottom of the window or other panel, thereby helping to preserve any slope of the forward portion 24. In one embodiment each of the ribs is substantially identical. However, they need not be. Adjoining ribs may be substantially identical or different relative to each other. For example, not all of the ribs along the length need to be the same size or shape as any adjoining rib. It is possible that there will be variations in one or more of the characteristics of a plurality of ribs along a length.

It is also seen in FIGS. 6A-6C that, over at least a portion of its length (if not the entirety thereof) the rearward portion 26 of the base 14 may be inclined at the same or more preferably at a different angle relative to the forward portion 24 of the base (with the base also being inclined relative to a horizontal plane). For example the rearward portion may have one or more slopes of about 1 to about 20 degrees or greater relative to a horizontal plane. More specifically, it may have one or more slopes of about 2 to about 10 degrees relative to a horizontal plane. It is generally expected that the forward portion outside of the ribs area will have a greater slope than the rearward portion of the base. However, it is possible that the rearward portion will have a greater slope than the forward portion.

Other variations of rib configurations are also possible. For example, the spacing of ribs toward a forward portion of the flashing may narrow and then expand toward the rear, and then narrow again. It may expand, narrow and then expand again. Similarly, the rib heights may increase and then decrease progressing from forward to rearward, or vice versa. Substantially all or part of the upper surface 36 of one or more ribs may be substantially parallel, and more preferably substantially co-planar with the rearward portion 26 of the base portion, with the forward portion of the base portion or both. Substantially all or part of the upper surface 36 of one or more of the ribs may be inclined relative to the rearward portion 26 of the base portion, relative to the forward portion 24 of the base portion or both. Substantially all or part of the upper surface 36 of one or more of the ribs may have a height that is above, below or substantially the same as the rearward portion 26 of the base portion. The upper surface 36 of one or more of the ribs may have one or more slopes, curvatures or both, along the depth of the rib, along the width of the rib, or both. The junctures between the walls 30 and upper surfaces 36 normally will include a radius (R) of curvature. It is also possible that any such radius will be omitted.

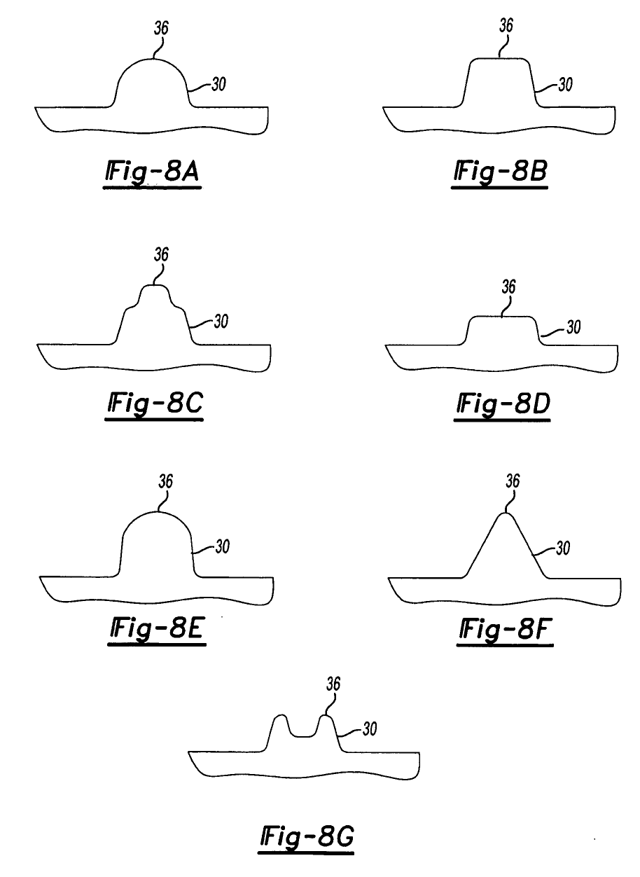

FIGS. 8A-8G illustrate examples of plan views or lateral cross-sectional views of alternative rib configurations. The ribs can have an arcuate upper surface 36 (e.g., embodiments (8A), (8E) and (8F)), substantially flat upper surface 36 (e.g., embodiments (8B), (8C) and (8D), one or more steps (e.g., embodiment (8C)), curved side walls 30 (e.g., embodiments (8A) and (8D)), substantially straight side walls 30 (e.g., embodiments (8B) and (8C) and (8E)-(8G)), one or more undulations in the upper surface 36 (e.g., embodiment (8G)), or any combination thereof.

Ribs may be located along substantially the entirety of the length of a flashing, or only partially along the length. For example, it is possible that ribs are present along about one half the total length or longer (e.g., about 70% of the length or longer). They also may be located along a shorter length of the flashing, for example, less than about one half of the length (e.g., about 35% of the length) or shorter. FIG. 2 illustrates how ribs are present less than about one half the length. The number of ribs may vary from about 1 to about 100 or more per flashing. More typically, the total number of ribs will be about 3 to about 50, and still more preferably about 8 to about 25 ribs.

It should be appreciated from the discussion thus far that dimensions depicted in the drawings are incorporated by reference herein. However, they are for sake of illustration and are not intended as limiting. Dimensions may be as little as about ¼ or even about 1/10 (or smaller) of the shown dimension, or as great as about 2 or even 4 times the shown dimension (or larger) To the extent that multiple dimensions are provided, the relative proportions of the dimensions are also included as within the scope of the present teachings. Thus for example, if a dimension of 32 is shown for length and a height of 5 is shown. Though dimensions shown are in inches, the invention also contemplates embodiments where such dimensions are in centimeters.

In one aspect of the invention, such as is shown in FIGS. 5A-6C, the junctures of two or more of the different wall portions that comprise the flashing structure (which as is seen may be a single, continuous piece), are radiused (see, e.g., illustrations of radiused junctures, designated by R in the drawings). One of the benefits of such as structure is that the radiused surfaces help avoid the creation of moisture collection sites. Of course, as indicated before, it is also possible that such junctures may be substantially free of any radius.

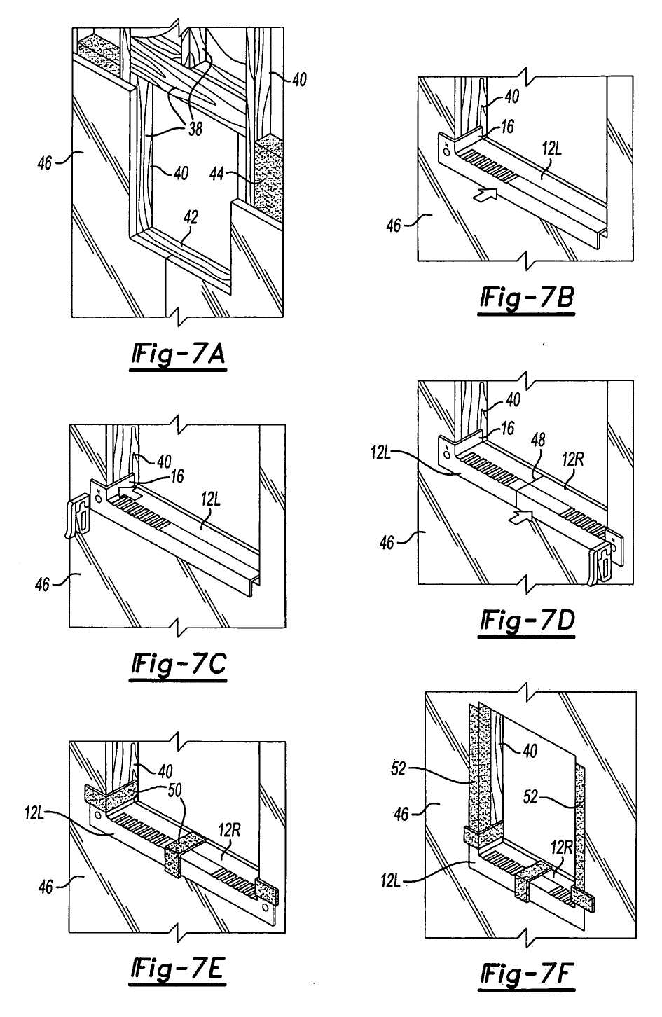

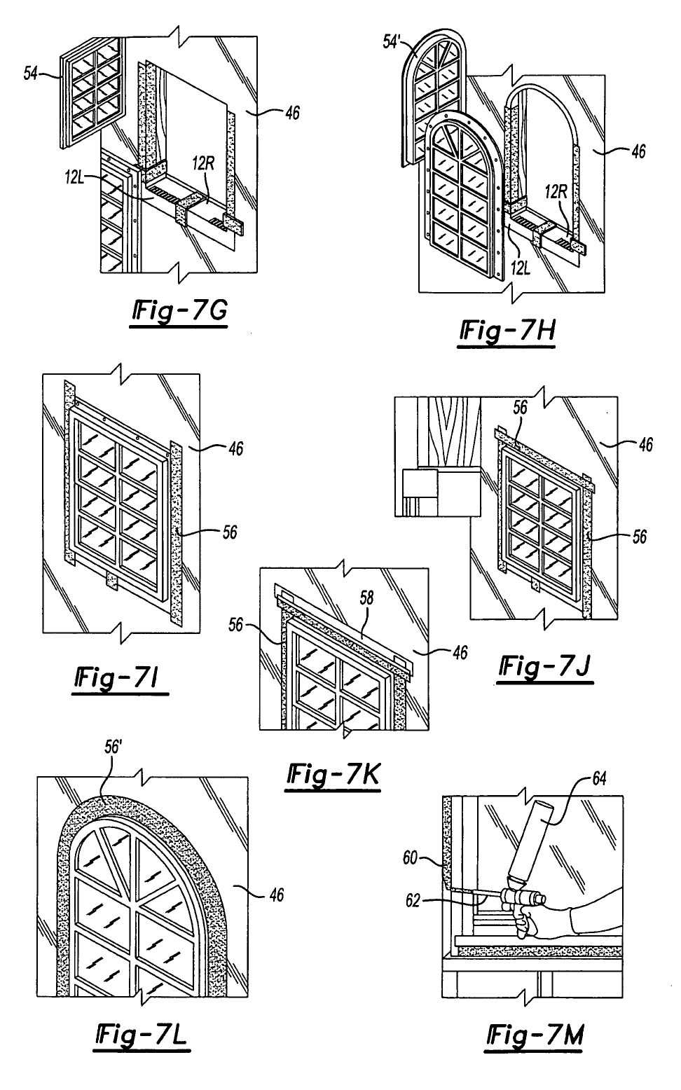

Turning now to FIGS. 7A-7M, a method of installing the flashings described herein is illustrated. A frame structure is built with framing members 38 (e.g., wood, metal or composite studs) to define an opening (e.g., for a window, a door or other covering or closure), that includes upwardly at least one upwardly projecting jamb 40 that adjoins (e.g., substantially orthogonally or at another angle) a base 42 (e.g., a sill, a threshold or otherwise). A space is defined between framing members 38 which may be filled with insulation 44, covered with an insulation panel 46 or other exterior covering, such as a weather-resistant barrier (e.g., a rigid foam, such as extruded polystyrene, polyisocyanurate, any combination thereof or otherwise or a water resistive barrier, such as housewrap, the like, or otherwise).

As shown in FIGS. 7B and 7C, first flashing 12L is placed over the base 42, by positioning it to overlap the insulation 44, insulation panel 46, or both. The flashing is secured to the structure with a suitable fastener, such as a nail, a screw or a staple (optionally according to one or more of the markings 22 provided on the flashing). Desirably, the flashing will rest on the base 42 (optionally without any intermediate shim members) and may even be in direct contact with the base. Provided that rough construction has been conducted properly, at least a portion of the base of the flashing, by virtue of its configuration is expected to slope toward the exterior of the structure. Thus, it is possible that the installation will be free of any step of adjusting the slope of the flashing base. In the event determined necessary, of course, the installation may include a step of adjusting the slope of the base of the flashing, such as by using a shim. By way of example, the flashing may include a “stand-off” that may extend longitudinally across at least a portion of the flashing. In one aspect, the stand-off may extend through the rearward portion 26 of the flashing (e.g., rearward of the ribs 20). It is appreciated that the stand-off may provide an additional elevation to the base 14, preferably, generally higher than the upper surface 36 of the ribs 20. As such, it is further appreciated that in one embodiment, the stand-off may be configured to substantially prevent a negative slope (e.g., sloping of the base 14 towards the window). In doing so, it is believed that the stand-off may prevent moisture or otherwise from being trapped near the window. Preferably the liquid moisture is funneled toward the front of the flashing and away from the window. In another aspect, it is contemplated that the stand-off may be supported by the flashing itself, the window framing, the like or otherwise, or any combination thereof. In one specific example, shims may be provided and positioned between the window framing or otherwise and the flashing. In doing so, the shims may further provide additional support, a means of leveling the flashing, or otherwise, or any combination thereof.

In FIGS. 7D and 7E, there is shown another step of installing a second flashing on the opposite side of the structure. In this instance, the flashing 12R is placed in overlapping relation with the first flashing 12L, and preferably, in direct facing contact therewith, so that the base 14 and the front surface of each overlap by at least about 3 cm, and more specifically at least about 5 cm. In one embodiment it is contemplated that the bases and the front surface are in overlapping relation over at least about 20% of the length of each flashing, or even greater than about 50% the length of each flashing. It is possible that an intermediate layer may be placed between the first flashing and the second flashing (e.g., a film, a tape, adhesive or otherwise). The second flashing 12R is attached to the structure in like manner as the first flashing 12L.

Optionally, one or more of the free ends 48 of the flashings opposite the end of the side flanges 16 are sealed together with the adjoining flashing at the seam. For example, in FIG. 7E, the ends are sealed with a tape 50 or flashing (e.g., WEATHERMATE® flashing from The Dow Chemical Company), such as a tape or flashing optionally including an adhesive backing. In addition, it is possible that the upper edge of the side flanges 16 are similarly sealed. Optionally, when an additional flashing member 52 is included (FIG. 7F), the tape 50 may be applied after the installation of the flashing 12, the additional flashing 52, or a combination of both, though not required. Preferably, the tape 50 may be applied over the over-lap of the end portion of the additional flashing 52 and the side flange 16 of the flashing 12 (FIG. 7F). In one aspect, thin walled film structures of the present invention offer an advantage over traditional sill flashing members by virtue of the substantially flush manner in which the flashings contact each other, adjoining structure to which it is attached or both. Not only is there a small gap between the flashing and the structures, the flexibility of the flashing allows it to substantially conform to the adjoining structure, and remain in place when taped down. In another aspect, the small gap may provide a location for applying a sealant (e.g., foam or otherwise), adhesives, insulation, reinforcement, the like or otherwise, or any combination thereof. Further, the bulk of the flashing will help minimize the torsional forces that would otherwise cause the flashing or tape 50 to separate from the underlying structure.

It will be appreciated that certain openings will have a base that exceeds the total length of both flashings. In that instance, it is possible to cut the side flange and corner portion from a second or additional piece of either the first or second flashings and use the remaining piece (exclusive of the corner portion and side flange) to cover the intermediate space. In this manner, the invention provides an advantage that only two distinct part types need be employed at a construction site. In the latter instances, care is generally taken to achieve the desired overlapping, contacting and sealed relation as described in the immediate preceding paragraphs.

It should be appreciated that throughout the installation process, steps are generally taken to help ensure that insulation, flashing, framing members and other materials are clean, dry, and/or substantially free of dust or debris.

In another embodiment according to FIG. 7F, one or more additional flashing members 52 (e.g., WEATHERMATE® Straight Flashing from The Dow Chemical Company) may be applied to help seal some or all of the remainder of the opening. When included, it is appreciated that at least one end of the flashing member 52 may be positioned above or below the side flange 16 of the flashing member 12L/12R, a top flashing member 56 (FIG. 7J), or a combination of both, though not required. Preferably, a lower first end of each flashing member 52 may be positioned above (e.g., overlapping) the respective side flange 16 of each of the flashing members 12L and 12R. Optionally or as an alternative, an upper second end of each of the flashing members 52 may be positioned under end portions of the flashing member 56, respectively, such that the end portions overlap the upper second ends of the flashing member 56. Advantageously, it is believed that one or more of these configurations may be configured to reduce or eliminate moisture or otherwise penetration into the structure therebeneath (e.g., framing or otherwise). Such flashing may be adhered to the underlying structure, fastened (e.g., using nails, screws, staples or otherwise) or both FIGS. 7F-7M. Desirably, the flashing members will include or be attached by an adhesive backing.

Turning to FIGS. 7G and 7H, a window 54 (54′) or other closure (e.g., door, screen or otherwise) is prepared for installation. For example, sealant, caulk or other agent may be applied at the window jambs and head, the nailing flange or a combination thereof. The window is placed in the opening, plumb, level and square. To the assembly, one or more additional flashing members 56 (e.g., an adhesive-backed straight flashing such as WEATHERMATE® Straight Flashing from The Dow Chemical Company) may be applied along the jambs, over the flashing members 12L/12R, a combination thereof, or elsewhere. Optionally a drip cap may also be employed.

With reference to FIGS. 7K and 7L, the header portion of the assembly is flashed with straight flashing (56), flexible flashing (56′), or both, (e.g., WEATHERMATE®) Straight Flashing from The Dow Chemical Company, WEATHERMATE® Flexible Flashing from The Dow Chemical Company, or both), which may be adhesively backed. Construction tape 58 (e.g., WEATHERMATE® Construction Tape from The Dow Chemical Company (such as in a 2⅞ inch width) may be applied over such flashing and/or any drip cap. For curved windows, the flexible flashing is generally cut to a length about 20 to 35 cm longer than the arc length of the window head and, taking care to avoid stretching the flashing, it is applied to overlap jamb flashings by a minimum of at least about 10 cm (e.g., at least about 15 cm). Optionally, outer edges of the flexible flashing may be held in place with a fastener (e.g., nail, screw or staple), an adhesive, or any combination thereof.

According to FIG. 7M, the assembly is further sealed, such as for helping prevent air infiltration. A sealant bead 60 is applied, using an applicator 62 for dispensing from a source 64 of sealer, around some or all of the perimeter. An example of such a sealer is a polymeric sealant (foamed or unfoamed in its applied state), such as an insulating foam commercially available under the designation GREAT STUFF™ from The Dow Chemical Company.

It should be borne in mind that, with reference to FIGS. 7A-7M, there are illustrated only examples of construction methods by which the flashings of the present invention may be employed in the construction of a building. Though illustrated by reference to a series of steps, the skilled artisan will appreciate that not all such steps are necessary. Certain of the steps may be substituted with other steps for achieving a similar result. In one of its most bare forms, the methods herein contemplate attaching a flashing as described herein to a frame structure that defines an opening. A window, door, screen, or other closure structure is then installed in the opening.

One or more additional steps may be employed for fabricating assemblies in accordance with the present methods. For example, as a result of rough construction, irregularities in either or both of size or shape of the window, door, screen, or other structure to be installed, or for other reasons, it may be desired or necessary to install a shim between the frame and the flashing. One embodiment of the present invention, however, contemplates an assembly that is free of any shim, and is particularly free of any shim between the flashing and the frame.

It should be recognized that any of a variety of manufacturing techniques may be employed to manufacture the flashings herein. Though injection molding, blow molding or other molding techniques are possible, one preferred approach is to employ thermoforming techniques, such as vacuum forming. The method of manufacturing the flashings herein generally includes providing a sheet of thermoformable plastic; placing it in contact with a tool, heating the thermoformable plastic to soften it (e.g., to a temperature ranging from about 80 to about 175° C.) to cause the thermoformable plastic to conform to the surface of the tool. A pressure is applied to force the plastic to conform with the tool surface. A suitable negative pressure (e.g., a vacuum) also may be drawn for causing the plastic to conform with the tool surface. A combination of a pressure application and a vacuum drawing may also be employed. The process typically involves subjecting the plastic to elevated temperature for several seconds to several minutes. However, more commonly, the elevated temperature steps will take less than one minute, and more specifically less than about 30 seconds (e.g., about 20 seconds).

In one approach, a single sheet or film of a plastic film is shaped against a die configured for yielding a plurality of flashings from the single sheet or film. After the sheet or film is formed, individual flashings can be cut. It may also be possible that the sheet or film is partially cut and thereafter cut for separation from one another at a remote location, such as at a job site.

It is desirable that the materials herein that are formed in accordance with the present teachings will be capable of exhibiting a modulus of elasticity (according to ASTM D638) of about 1000 to about 4000 MPa (e.g., greater than about 2000 MPa, or even about 2900-3400 MPa); an ultimate tensile strength (according to ASTM D882) of about 20 to about 90 MPa (e.g., about 50 to 80 MPa); or both.

Desirably the material is capable of softening for forming at a temperature below about 200° C., and more specifically below about 165° C. (e.g., about 150° C. or lower). In this manner that invention herein also provides a benefit in that it can be practiced with techniques that are relatively slight in their requirements for the use of costly and scarce energy. It is believed that the unique structure described herein, especially when employed in combination with the particular material characteristics helps to provide benefits to the flashings herein. For example, the material is believed to be tough enough to avoid rupture during window installations, such as from sharp edge corners commonly encountered in many commercial windows. Further, the bending resistance inherent in the rib structures can be enhanced by selection of material. In this manner, it is believed that the flashings will withstand application of pressure for long durations. Further the combination of the linear expansion properties and the strength characteristics helps to avoid rupture in service. Examples of materials include polyvinylchloride, polypropylene, polyethylene, polystyrene, polyethylene terephthalate, polycarbonate, polyimide, polyester, or any combination thereof. One particularly preferred material is selected from polyvinylchloride, polyester, or a combination thereof. Laminates that include two or more polymeric materials (e.g., a film prepared by a co-extrusion) are also possible for use herein. Films employed herein may be oriented, e.g., mono-axially, biaxially or otherwise).

The material employed may optionally be selected or processed so that it has a relatively low coefficient of friction. For example, it is possible to employ a low-friction coating, film or other surface modification (e.g., including one or any combination of a silicone, a fluorinated polymer (e.g., polytetrafluoroethylene), a polyolefin, or any combination thereof). In one embodiment, the low friction coating, film or other modification has a thickness that is less than about 25% (or even less than about 10%) of the thickness of the film of the flashing.

In one aspect of the invention, the flashings 12 are substantially opaque. However, one preferred approach is to have the flashings 12 include a transparent portion over at least a portion of its length. For example, it may have a transparent portion over at least about 50%, and even at least about 75% of its length. In one embodiment, the flashings are generally transparent over substantially the entirety of its length. In this manner, it provides an advantage to installers who are able to view underlying structure through the flashing during installation. Further, it is possible that the flashings will include a colorant over some or all of its length. For example, one approach is to employ a colorant for rendering the flashing blue, or some other color. Furthermore, another approach is to employ a colorant for visual identification of the flashing (e.g., during an inspection of the widow, the building, or otherwise). In one embodiment, the color may be selected to protect an underlying surface from the penetration of certain radiation. For example, it may be desirable to delay curing by light of an adhesive or sealant that underlies the flashing, while preserving visibility of the adhesive or sealant.

The flashing herein may be provided alone or with one or more other construction materials, such as in a kit. Advantageously, the structure of the flashing permits it to be packaged and transported in a relatively compact volume, such as achievable by stacking a plurality of the flashings so that their respective face portions are in contact with each other.

Also contemplated as within the scope of the present invention are kits, pursuant to which the flashings herein are offered, sold, packaged, or shipped in combination with one or more additional construction materials, such as a material selected from an insulation, an insulation panel (e.g., including an expanded polymeric material such as polystyrene or polyurethane), a sheet, a film, a tape, an adhesive, a sealant, an insulating foam, attachment fasteners (e.g., staples, nails, screws or otherwise), a closure panel (e.g., a door, a window, a screen or otherwise), or any combination thereof.

As has been shown, the present invention is directed to improved articles, assemblies, methods and kits that relate to flashings for openings in building structures, and more particularly to flashings that are installed during or substantially immediately following rough carpentry in new construction of residential dwellings, including but not limited to residential homes, apartments, condominiums, dormitories, or other such structures. The invention is not so limited, however, as it may also find application in the construction of commercial buildings, industrial buildings, or other structures occupied by humans, animals or both. Though illustrated in connection with new construction, the invention is not so limited. It also has applicability in one or more of the fields of repair, reconstruction or replacement of building components (such as doors, windows, screens, or other closure structures).

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

What is claimed is:

1. An improved flashing for sealing an opening of an architectural structure, comprising:
a) a generally vertically disposed substantially planar forward portion having an upper end and a lower end; and
b) a base portion rearwardly projecting generally from the upper end of the forward portion and having an upper surface that includes a generally inclined portion and also including a plurality of outwardly projecting ribs spaced apart from each other and including a valley floor therebetween.

2. The flashing of claim 1, wherein the wall thickness throughout the flashing is on the order of about 0.1 to about 2 mm.

3. The flashing of claim 2, wherein the flashing consists essentially of a thermoplastic film having a thickness less than about 1.3 mm.

4. The flashing of claim 1, wherein the inclined portion, the ribs, or both include a surface inclined at an angle of less than about 10°.

5. The flashing of claim 4, wherein the flashing is substantially transparent throughout its length.

6. The flashing of claim 5, wherein the flashing is colored.

7. The flashing of claim 1, wherein the flashing includes side wall portions, a rear wall extending generally upwardly from the base portion, or both.

8. The flashing of claim 7, wherein the flashing includes a coating over at least part of the base portion, is substantially free of any coating over at least a portion of the base portion, or a combination thereof.

9. The flashing of claim 1, wherein the base portion includes a forward portion and a rearward portion, and the forward portion has a slope differing from any slope of the rearward portion.

10. The flashing of claim 9, wherein the ribs include an upper surface that is substantially horizontally disposed, the valley floor is substantially horizontally disposed, or both.

11. The flashing of claim 10, wherein the ribs have an average depth extending rearwardly from the planar forward portion that is about 0.1 to about 0.8 of the depth of the base portion.

12. The flashing of claim 11, wherein the forward portion of the base includes a portion that is inclined relative to the upper surface of one or more ribs defined thereon.

13. The flashing of claim 12, wherein the upper surface of one or more ribs is substantially flat, has a curvature, defines one or more peaks, or any combination thereof.

14. An architectural assembly comprising a structural frame defining an opening and a flashing that includes:
a) a generally vertically disposed substantially planar forward portion having an upper end and a lower end; and
b) a base portion rearwardly projecting generally from the upper end of the forward portion and having an upper surface that includes a generally inclined portion and also including a plurality of outwardly projecting ribs spaced apart from each other and including a valley floor therebetween.

15. The architectural assembly of claim 14, wherein the assembly is free of any shim beneath the flashing.

16. The architectural assembly of claim 15, wherein the flashing is secured to the structural frame by at least one bead of adhesive tape, a staple, a fastener, or any combination thereof.

17. A kit for constructing an architectural assembly comprising:
a flashing that includes:
a) a generally vertically disposed substantially planar forward portion having an upper end and a lower end; and
b) a base portion rearwardly projecting generally from the upper end of the forward portion and having an upper surface that includes a generally inclined portion and also including a plurality of outwardly projecting ribs spaced apart from each other and including a valley floor therebetween; and
one or more additional material selected from an insulation, an insulation panel, a sheet, a film, a tape, an adhesive, a sealant, an insulating foam, attachment fasteners, a closure panel, or any combination thereof.

18. A method of transporting a plurality of flashings that include a) a generally vertically disposed substantially planar forward portion having an upper end and a lower end; and b) a base portion rearwardly projecting generally from the upper end of the forward portion and having an upper surface that includes a generally inclined portion and also including a plurality of outwardly projecting ribs spaced apart from each other and including a valley floor therebetween, comprising the steps of:
stacking a plurality of flashings so that the upper surface of a base portion of a first flashing contacts a lower surface of a base portion of a second flashing.

19. A method for making a sill flashing comprising the step of:
thermoforming a thermoplastic film to form the sill flashing that includes a) a generally vertically disposed substantially planar forward portion having an upper end and a lower end; and b) a base portion rearwardly projecting generally from the upper end of the forward portion and having an upper surface that includes a generally inclined portion and also including a plurality of outwardly projecting ribs spaced apart from each other and including a valley floor therebetween.

20. A method of claim 19, wherein the step of thermoforming includes application of a negative pressure during at least a portion of the forming.
